(19) United States
(12) Patent Application Publication
(10) Pub. No.: US 2022/0369641 A1
(43) Pub. Date: Nov. 24, 2022

(54) MOLECULAR COMPLEXES

(71) Applicant: Johnson Matthey Public Limited Company, London (GB)

(72) Inventors: Thierry BONNAUD, Cambridge (GB); David CALVERT, Keyingham (GB); Alan CHORLTON, Cambridge (GB); David GRASSI, Rorschach (CH); Thomas KENDALL, Cambridge (GB); Jose VILLORIA, Reading (GB)

(21) Appl. No.: 17/633,050

(22) PCT Filed: Aug. 6, 2020
(86) PCT No.: PCT/GB2020/051880

§ 371 Date: Feb. 4, 2022

(30) Foreign Application Priority Data
Aug. 7, 2019 (GB) 1911304.2

(51) Int. Cl. A01N 43/90; A01N 39/04; A01N 37/40; A01N 43/40

(52) U.S. Cl. CPC A01N 43/90; A01N 39/04; A01N 37/40; A01N 43/40

(57) ABSTRACT

The present invention relates to a crystalline molecular complex comprising:
(a) the herbicide pinoxaden, and
(b) a second herbicide selected from the group consisting of fluroxypyr, 2,4-dichlorophenoxyacetic acid, 2-methyl-4-chlorophenoxyacetic acid and 3,6-dichloro-2-methoxybenzoic acid.

The invention also relates to processes for the preparation of the crystalline molecular complex, a herbicidal composition comprising the crystalline molecular complex, and use of the herbicidal composition.

The present invention relates to molecular complexes of the herbicide pinoxaden. In particular, the invention relates to molecular complexes comprising pinoxaden with active herbicidal coformers, and to herbicidal compositions comprising such molecular complexes.

Pinoxaden has the chemical name [8-(2,6-diethyl-4-methylphenyl)-7-oxo-1,2,4,5-tetrahydropyrazolo[1,2-d][1,4,5]oxadiazepin-9-yl] 2,2-dimethylpropanoate and the chemical structure as illustrated below:

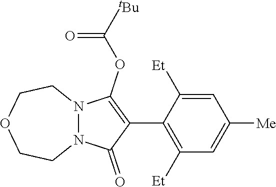 [SMILES: CCc1cc(C)cc(CC)c1-c1c(OC(=O)C(C)(C)C)n2n(c1=O)CCOCC2]

2,4-Dichlorophenoxyacetic acid (2,4-D) and 2-methyl-4-chlorophenoxyacetic acid (MCPA) are widely used systemic herbicides which is a member of the phenoxy family of herbicides. 2,4-D and MCPA act as synthetic auxins. A synthetic auxin is a plant hormone which is absorbed by the leaves of plants. 2,4-D and MCPA are used to control broadleaf weeds, in particular for agricultural applications.

Fluroxypyr is a herbicide, which is also a synthetic auxin. It is used to control broadleaf weeds and woody brush.

3,6-Dichloro-2-methoxybenzoic acid (dicamba) is a selective systemic herbicide which is used to control annual and perennial grasses and broad-leaf weeds.

An increasing number of weed populations have been identified which show resistance to 2,4-D, MCPA, dicamba, and fluroxypyr, and the spread of these resistant populations could have a significant impact on the effectiveness of these herbicides. One strategy to overcome such issues is the use of the herbicides in combination with one or more additional herbicide compounds with alternative modes of action. The development of a single formulation containing each of the herbicide compounds to be applied in combination is attractive. For example, the development of such formulations can reduce the need for multiple applications of herbicide, can help to ensure consistent delivery of the desired ratio of each herbicide compound, and can reduce delivery costs.

However, the development of such formulations incorporating two herbicides is challenging. For example, a single combination formulation must provide conditions in which both herbicidal compounds are stable.

The relatively high aqueous solubility of dicamba may make consistent application with less soluble compounds problematic. Furthermore, formulations comprising dicamba may suffer from loss from the site of application due to the relatively high volatility and aqueous solubility of dicamba.

The development of formulations incorporating 2,4-D is challenging due to the physicochemical properties of 2,4-D. In particular, the high volatility of 2,4-D can lead to a number of issues. For example, the evaporation of 2,4-D from a formulation after application can lead to environmental issues, such as a strong odour and movement off the application site (herbicide drift). High volatility can also lead to a reduction in efficacy of the applied formulation, and a change from the desired ratio of actives in multi-component formulations.

In addition, if synergistic effects are desired, the relatively high aqueous solubility of 2,4-D can lead to potential problems in the development of combination formulations with less water soluble active agents, due to the relatively rapid release of 2,4-D after application.

The relatively high aqueous solubility of MCPA can lead to potential problems in the development of combination formulations with less water soluble active agents due to the relatively rapid release of MCPA after application.

There remains a need to develop new stable herbicide formulations containing at least two herbicides which overcome one or more of the issues identified above.

Definitions

The term “about” or “approximately” means an acceptable error for a particular value as determined by a person of ordinary skill in the art, which depends in part on how the value is measured or determined. In certain embodiments, the term “about” or “approximately” means within 1, 2, 3 or 4 standard deviations. In certain embodiments, the term “about” or “approximately” means within 30%, 25%, 20%, 15%, 10%, 9%, 8%, 7%, 6%, 5%, 4%, 3%, 2%, 1%, or 0.5% of a given value or range. In certain embodiments and with reference to X-ray powder diffraction two-theta peaks, the terms “about” or “approximately” means within ±0.2° 2θ.

The “active herbicidal coformer” or “herbicidal coformer” referred to in the present specification is the second herbicide selected from the group consisting of fluroxypyr, 2,4-dichlorophenoxyacetic acid, 2-methyl-4-chlorophenoxyacetic acid and 3,6-dichloro-2-methoxybenzoic acid.

The term “ambient temperature” means one or more room temperatures between about 15° C. to about 30° C., such as about 15° C. to about 25° C.

The term “crystalline” and related terms used herein, when used to describe a compound, substance, modification, material, component or product, unless otherwise specified, means that the compound, substance, modification, material, component or product is substantially crystalline as determined by X-ray diffraction. See, e.g., Remington: The Science and Practice of Pharmacy, 21st edition, Lippincott, Williams and Wilkins, Baltimore, Md. (2005); The United States Pharmacopeia, 23rd ed., 1843-1844 (1995).

The term “molecular complex” is used to denote a crystalline material composed of two or more different components which has a defined single-phase crystal structure. The components are held together by non-covalent bonding, such as hydrogen bonding, ionic bonding, van der Waals interactions, π-π interactions, etc. The term “molecular complex” includes salts, co-crystals and salt/co-crystal hybrids. In one embodiment, the molecular complex is a salt. In another embodiment, the molecular complex is a co-crystal. In another embodiment, the molecular complex is a salt/co-crystal hybrid.

Without wishing to be bound by theory, it is believed that when the molecular complex is a co-crystal, the co-crystal demonstrates improved physiochemical properties, such as crystallinity, solubility properties and/or modified melting points. In certain embodiments, the melting point of the molecular complex may be higher than the melting point of pinoxaden itself and/or the active coformer itself. In this instance, a higher melting point may be of benefit in the preparation of, for example, a suspension concentrate formulation of the molecular complex. In certain embodiments, the melting point of the molecular complex may be lower than the melting point of pinoxaden itself and/or the active coformer itself. In this instance, a lower melting point may be of benefit in the preparation of, for example, an encapsulated formulation of the molecular complex or liquid formulation of the molecular complex.

The molecular complexes may be distinguished from mixtures of pinoxaden and the selected molecular complex former, by standard analytical means which are well known to those skilled in the art, for example X-ray powder diffraction (XRPD), single crystal X-ray diffraction, or differential scanning calorimetry (DSC). The molar ratio of the components of the molecular complex may be determined using, for example, HPLC or ¹H-NMR.

The term “overnight” refers to the period of time between the end of one working day to the subsequent working day in which a time frame of about 12 to about 18 hours has elapsed between the end of one procedural step and the instigation of the following step in a procedure.

“Slurry” means a heterogeneous mixture of at least a portion of the molecular complex in one or more solvents. “Slurry” therefore includes a mixture of molecular complex which is partially present as a solid, as well as being partially dissolved in the one or more solvents.

### DESCRIPTION OF THE FIGURES

FIG. 1 shows a representative x-ray diffraction pattern (XRPD) of the molecular complex of Example 2.

FIG. 2 shows a representative differential scanning calorimetry (DSC) curve for the molecular complex of Example 2.

FIG. 3 shows a representative x-ray diffraction pattern (XRPD) of the molecular complex of Example 3.

FIG. 4 shows a representative differential scanning calorimetry (DSC) curve for the molecular complex of Example 3.

FIG. 5 shows a representative x-ray diffraction pattern (XRPD) of the molecular complex of Example 4.

FIG. 6 shows a representative differential scanning calorimetry (DSC) curve for the molecular complex of Example 4.

FIG. 7 shows a representative x-ray diffraction pattern (XRPD) of the molecular complex of Example 5.

FIG. 8 shows a representative differential scanning calorimetry (DSC) curve for the molecular complex of Example 5.

FIG. 9 shows a view of the asymmetric unit of the crystal structure for the pinoxaden:fluroxypyr molecular complex of Example 2.

FIG. 10 illustrates how centrifugal forces are applied to particles in the Speedmixer™. FIG. 10A is a view from above showing the base plate and basket. The base plate rotates in a clockwise direction.

FIG. 10B is a side view of the base plate and basket.

FIG. 10C is a view from above along line A in FIG. 10B. The basket rotates in an anti-clockwise direction.

### DESCRIPTION OF THE INVENTION

It is an object of the present invention to provide a crystalline molecular complex comprising (a) the herbicide pinoxaden, and (b) a second herbicide selected from the group consisting of fluroxypyr, 2,4-D, MCPA and dicamba. In certain embodiments, the crystalline molecular complex is purifiable. In certain embodiments, the crystalline molecular complex facilitates obtaining pinoxaden in an improved purity. In certain embodiments, the crystalline molecular complex is stable. In certain embodiments, the crystalline molecular complex is easy to isolate and handle. In certain embodiments, the process for preparing the crystalline molecular complex is scalable. In certain embodiments, the dissolution rates of the crystalline molecular complex is higher than the dissolution rate of pinoxaden itself.

The crystalline forms described herein may be characterised using a number of methods known to the skilled person in the art, including single crystal X-ray diffraction, X-ray powder diffraction (XRPD), differential scanning calorimetry (DSC), thermal gravimetric analysis (TGA), infrared spectroscopy, Raman spectroscopy, nuclear magnetic resonance (NMR) spectroscopy (including solution and solid-state NMR). The purity of the crystalline forms provided herein may be determined by standard analytical methods, such as thin layer chromatography (TLC), gas chromatography, high performance liquid chromatography (HPLC), and mass spectrometry (MS).

In one aspect, the present invention provides a crystalline molecular complex comprising:
(a) the herbicide pinoxaden, and
(b) a second herbicide selected from the group consisting of fluroxypyr, 2,4-dichlorophenoxyacetic acid, 2-methyl-4-chlorophenoxyacetic acid and 3,6-dichloro-2-methoxybenzoic acid.

The molar ratio of pinoxaden:the second herbicide may be from about 0.1:about 5 to about 5:about 0.1. In one embodiment, the molar ratio of pinoxaden:the second herbicide may be about 1:about 1.

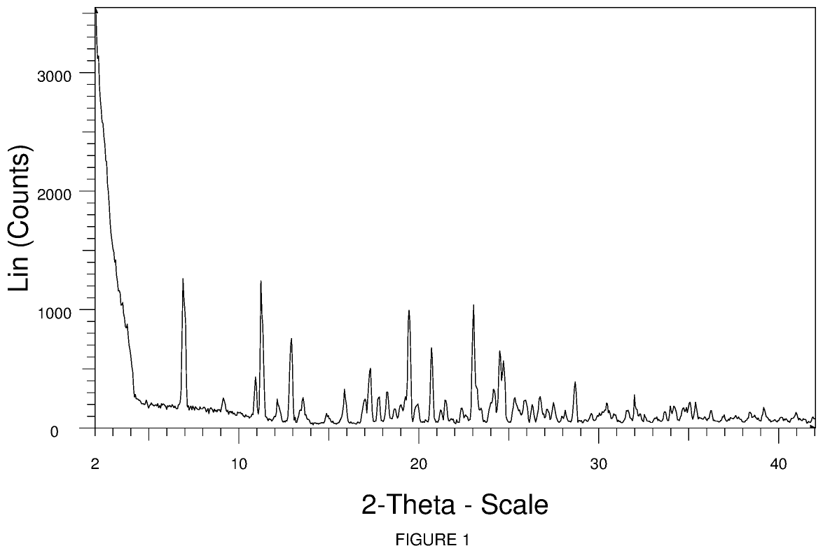

In one embodiment, the molecular complex is a crystalline pinoxaden fluroxypyr molecular complex. The molecular complex may have an X-ray powder diffraction pattern comprising one or more peaks (for example, 1, 2, 3, 4, 5, 6, 7, 8, 9, or 10 peaks) selected from the group consisting of about 6.8, 9.1, 10.8, 11.2, 12.1, 12.8, 13.3, 13.5, 13.7, 14.8, 15.7, 15.8, 17.0, 17.2, 17.7, 18.2, 18.6, 18.9, 19.2, 19.4, 19.8, 19.9, 20.7, 21.2, 21.4, 22.3, 22.6, 23.0, 23.2, 23.4, 23.9, 24.1, 24.5, 24.7, 25.2, 25.5, 25.9, 26.3, 26.8, 27.1, 27.5, 28.0, 28.1, 28.7, 29.5, 30.0, 30.2, 30.4, 30.6, 30.8, 31.6, 32.0, 32.3, 33.7, 34.0, 34.2, 34.6, 34.7, 35.1, 35.4, 35.8, 36.2, 38.4, 39.2, and 41.0 degrees two-theta±0.2 degrees two-theta. In one embodiment, the molecular complex may have the X-ray powder diffraction pattern substantially as shown in FIG. 1.

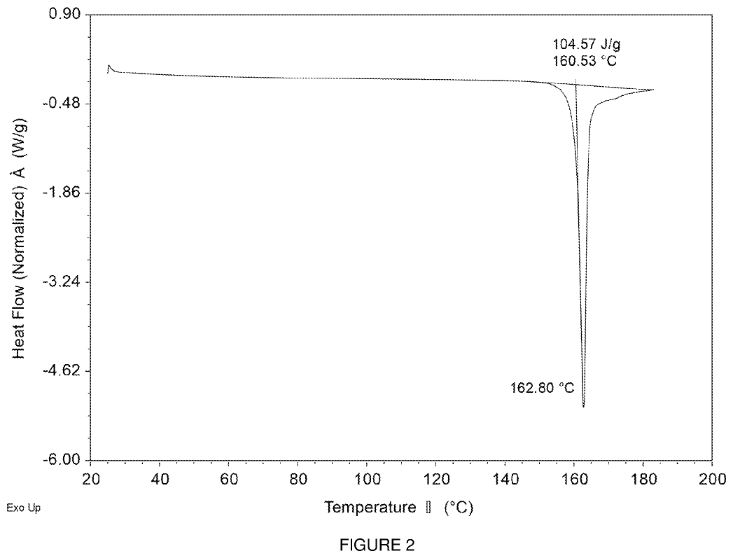

The molecular complex may have a DSC thermogram comprising an endothermal event with an onset temperature at about 160.5° C. In one embodiment, the molecular complex may have a DSC thermogram substantially as shown in FIG. 2.

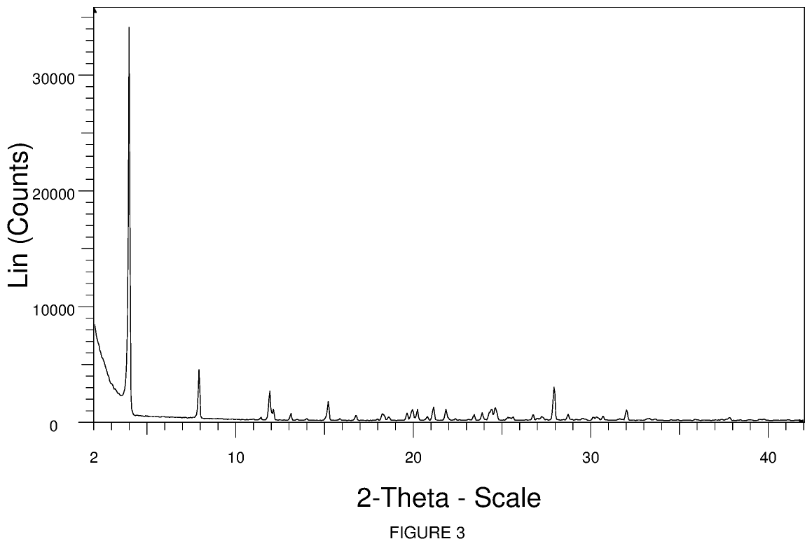

In one embodiment, the molecular complex is a crystalline pinoxaden 2,4-dichlorophenoxyacetic acid molecular complex. The molecular complex may have an X-ray powder diffraction pattern comprising one or more peaks (for example, 1, 2, 3, 4, 5, 6, 7, 8, 9, or 10 peaks) selected from the group consisting of about 3.9, 7.9, 11.4, 11.9, 12.1, 13.1, 14.0, 15.1, 15.8, 16.8, 18.0, 18.2, 18.6, 19.6, 19.9, 20.2, 20.8, 21.1, 21.9, 23.4, 23.9, 24.3, 24.4, 24.7, 25.3, 25.4, 25.6, 26.7, 27.0, 27.2, 27.9, 28.7, 30.1, 30.3, 30.7, 32.0, 33.3, and 37.8 degrees two-theta±0.2 degrees two-theta. In one embodiment, the molecular complex may have the X-ray powder diffraction pattern substantially as shown in FIG. 3.

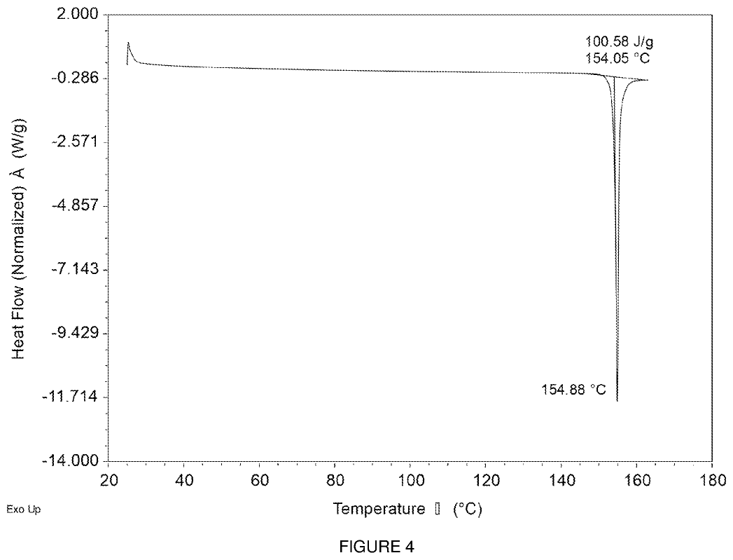

The molecular complex may have a DSC thermogram comprising an endothermal event with an onset temperature at about 154.1° C. In one embodiment, the molecular complex may have a DSC thermogram substantially as shown in FIG. 4.

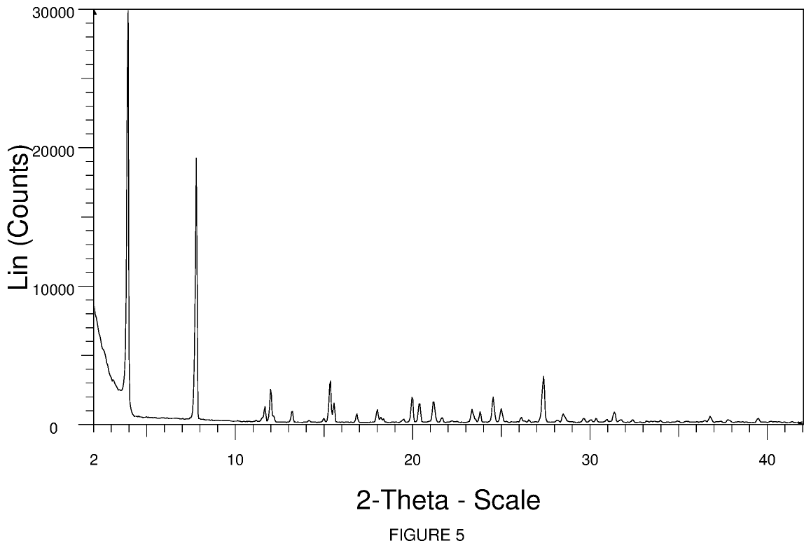

In one embodiment, the molecular complex is a crystalline pinoxaden 2-methyl-4-chlorophenoxyacetic acid molecular complex. The molecular complex may have an X-ray powder diffraction pattern comprising one or more peaks (for example, 1, 2, 3, 4, 5, 6, 7, 8, 9, or 10 peaks) selected from the group consisting of about 3.9, 7.7, 11.6, 12.0, 13.2, 14.1, 14.9, 15.4, 15.6, 16.8, 18.0, 18.2, 19.5, 19.9, 20.4, 21.1, 21.7, 22.2, 23.4, 23.8, 24.6, 25.0, 26.1, 26.6, 27.4, 28.5, 29.7, 30.1, 30.4, 31.0, 31.4, 31.8, 32.4, 35.0, 36.8, 37.8, and 39.5 degrees two-theta±0.2 degrees two-theta. In one embodiment, the molecular complex may have the X-ray powder diffraction pattern substantially as shown in FIG. 5.

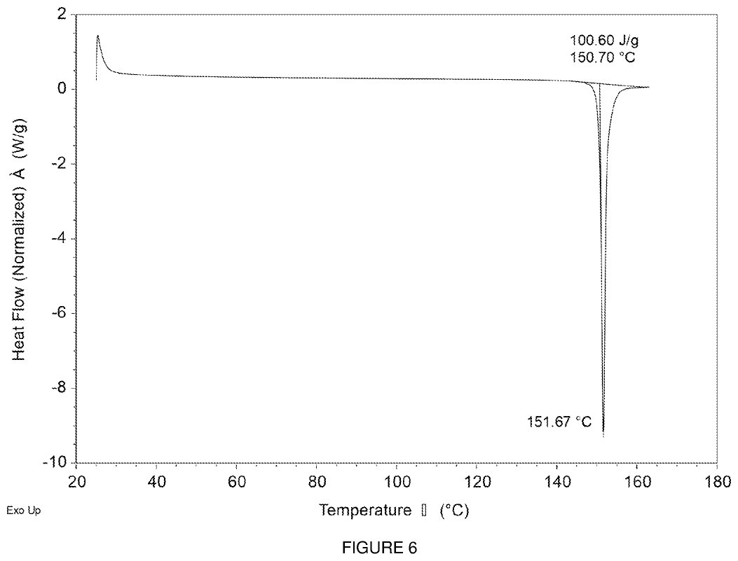

The molecular complex may have a DSC thermogram comprising an endothermal event with an onset temperature at about 150.7° C. In one embodiment, the molecular complex may have a DSC thermogram substantially as shown in FIG. 6.

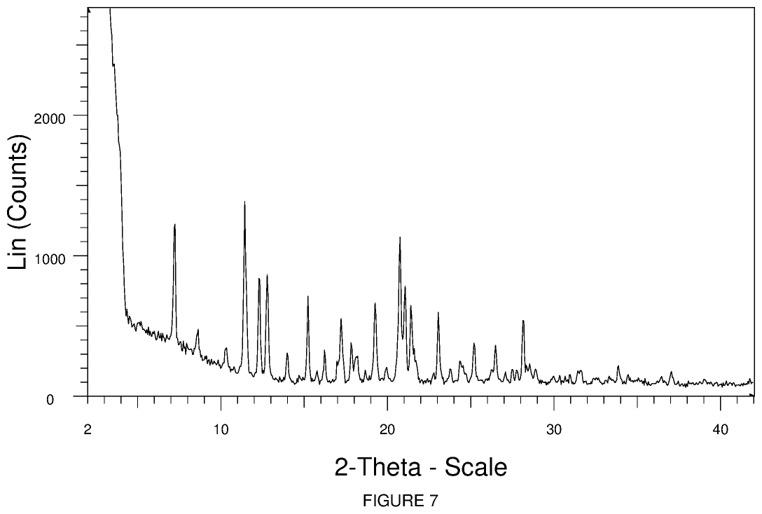

In one embodiment, the molecular complex is a crystalline pinoxaden 3,6-dichloro-2-methoxybenzoic acid molecular complex. The molecular complex may have an X-ray powder diffraction pattern comprising one or more peaks (for example, 1, 2, 3, 4, 5, 6, 7, 8, 9, or 10 peaks) selected from the group consisting of about 7.2, 8.6, 10.3, 11.4, 12.2, 12.8, 13.9, 15.2, 15.7, 16.2, 16.9, 17.2, 17.8, 18.2, 18.7, 19.3, 19.9, 20.7, 21.0, 21.4, 21.6, 22.8, 23.0, 23.8, 24.4, 25.2, 26.2, 26.4, 27.1, 27.4, 27.8, 28.2, 28.5, 28.9, 31.4, 31.6, 33.9, and 37.1 degrees two-theta±0.2 degrees two-theta. In one embodiment, the molecular complex may have the X-ray powder diffraction pattern substantially as shown in FIG. 7.

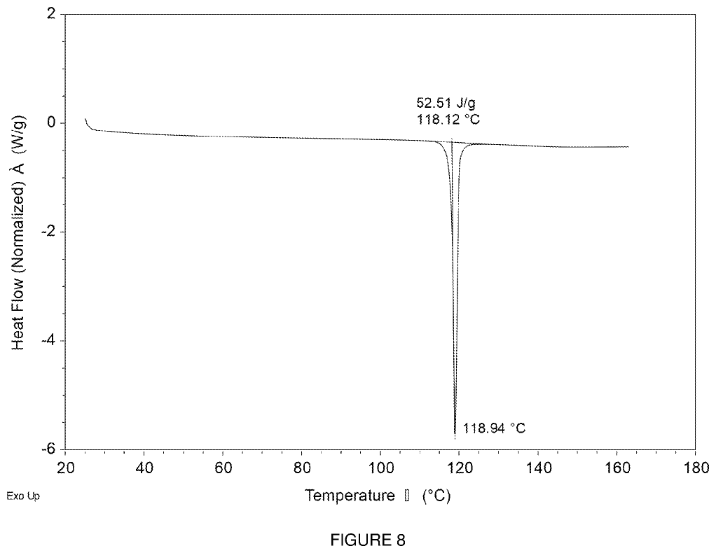

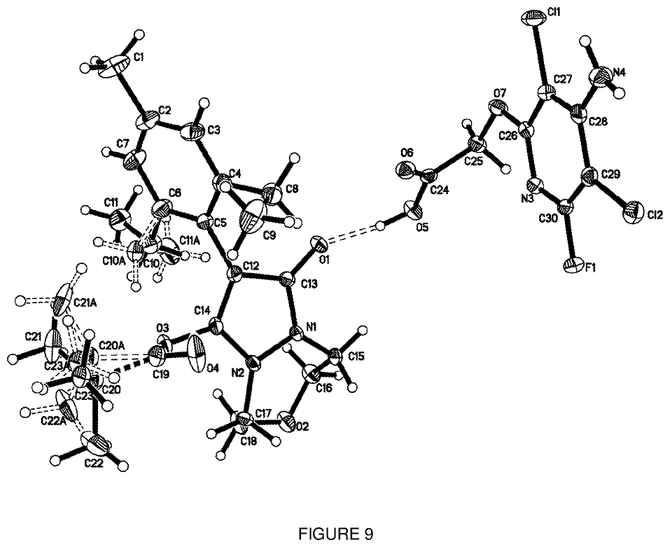

The molecular complex may have a DSC thermogram comprising an endothermal event with an onset temperature at about 118.1° C. In one embodiment, the molecular complex may have a DSC thermogram substantially as shown in FIG. 8.

The molecular complexes of pinoxaden and active herbicidal coformers described above may be prepared by a process comprising the step of reacting pinoxaden and a second herbicide using low energy ball milling or low energy grinding,

wherein the second herbicide selected from the group consisting of fluroxypyr, 2,4-dichlorophenoxyacetic acid, 2-methyl-4-chlorophenoxyacetic acid and 3,6-dichloro-2-methoxybenzoic acid.

When low energy ball milling is utilised, the milling process may be controlled by various parameters including the speed at which the milling takes place, the length of milling time and/or the level to which the milling container is filled.

The speed at which the milling takes place may be from about 200 rpm to about 5000 rpm. In one embodiment, the speed may be from about 75 rpm to about 750 rpm. In another embodiment, the speed may be from about 80 rpm to about 600 rpm. In one embodiment, the speed may be about 500 rpm.

Low energy grinding involves shaking the materials within a grinding container. The grinding occurs via the impact and friction of the materials within the container. The process may be controlled by various parameters including the frequency at which the grinding takes place, the length of grinding time and/or the level to which the container is filled.

The frequency at which the grinding takes place may be from about 1 Hz to about 100 Hz. In one embodiment, the frequency may be from about 10 Hz to about 70 Hz. In another embodiment, the frequency may be from about 20 Hz to about 50 Hz. In one embodiment, the frequency may be about 30 Hz.

Milling or grinding media may be used to assist the reaction. In this instance, the incorporation of hard, non-contaminating media can additionally assist in the breakdown of particles where agglomeration has occurred, for example, as a result of the manufacturing process or during transit. Such breakdown of the agglomerates further enhances the reaction of pinoxaden with the herbicidal coformer. The use of milling/grinding media is well-known within the field of powder processing and materials such as stabilised zirconia and other ceramics are suitable provided they are sufficiently hard or ball bearings e.g. stainless steel ball bearings.

Regardless of whether milling or grinding is used, an improvement in the process can be made by controlling the particle ratio, the size of the milling/grinding media and other parameters as are familiar to the skilled person.

The length of milling or grinding time may be from about 1 minute to about 2 days, for example, about 10 minutes to about 5 hours, such as about 20 minutes to 3 hours.

The process may be carried out in a wet environment i.e. an environment where solvent is present. For example, acetonitrile may added to the mixture of pinoxaden and herbicidal coformer. Acetonitrile can act to minimise particle welding. The addition of acetonitrile may be particularly helpful if the pinoxaden and/or herbicidal coformer being reacted has agglomerated prior to use, in which case the acetonitrile can assist with breaking down the agglomerates.

The herbicidal coformer may be present in stoichiometric or excess molar equivalents to the pinoxaden. In one embodiment, the herbicidal coformer is present in stoichiometric quantities.

Alternatively, the pinoxaden active herbicidal coformer molecular complex as described above may be prepared by a process comprising the step of applying dual asymmetric centrifugal forces to a mixture of pinoxaden and a second herbcide to form the molecular complex,

wherein the second herbicide selected from the group consisting of fluroxypyr, 2,4-dichlorophenoxyacetic acid, 2-methyl-4-chlorophenoxyacetic acid and 3,6-dichloro-2-methoxybenzoic acid.

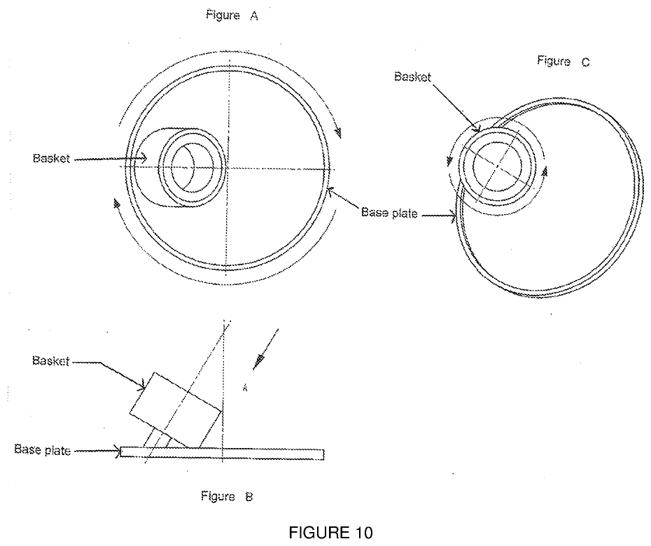

The molecular complex of pinoxaden herbicidal coformer is formed using dual asymmetric centrifugal forces. By “dual asymmetric centrifugal forces” we mean that two centrifugal forces, at an angle to each other, are simultaneously applied to the particles. In order to create an efficient mixing environment, the centrifugal forces preferably rotate in opposite directions. The Speedmixer™ by Hauschild (http://www.speedmixer.co.uk/index.php) utilises this dual rotation method whereby the motor of the Speedmixer™ rotates the base plate of the mixing unit in a clockwise direction (see FIG. 10A) and the basket is spun in an anti-clockwise direction (see FIGS. 10B and 10C).

The process may be controlled by various parameters including the rotation speed at which the process takes place, the length of processing time, the level to which the mixing container is filled, the use of milling media and/or the control of the temperature of the components within the milling pot.

The dual asymmetric centrifugal forces may be applied for a continuous period of time. By “continuous” we mean a period of time without interruption. The period of time may be from about 1 second to about 10 minutes, such as about 5 seconds to about 5 minutes, for example, about 10 seconds to about 200 seconds e.g. 2 minutes.

Alternatively, the dual asymmetric centrifugal forces may be applied for an aggregate period of time. By “aggregate” we mean the sum or total of more than one periods of time (e.g. 2, 3, 4, 5 or more times). The advantage of applying the centrifugal forces in a stepwise manner is that excessive heating of the particles can be avoided. The dual asymmetric centrifugal forces may be applied for an aggregate period of about 1 second to about 20 minutes, for example about 30 seconds to about 15 minutes and such as about 10 seconds to about 10 minutes e.g. 6 minutes. In one embodiment, the dual asymmetric centrifugal forces are applied in a stepwise manner with periods of cooling therebetween. In another embodiment, the dual asymmetric centrifugal forces may be applied in a stepwise manner at one or more different speeds.

The speed of the dual asymmetric centrifugal forces may be from about 200 rpm to about 4000 rpm. In one embodiment, the speed may be from about 300 rpm to about 3750 rpm, for example about 500 rpm to about 3500 rpm. In one embodiment, the speed may be about 3500 rpm. In another embodiment, the speed may be about 2300 rpm.

The level to which the mixing container is filled is determined by various factors which will be apparent to the skilled person. These factors include the apparent density of the pinoxaden and herbicidal coformer, the volume of the mixing container and the weight restrictions imposed on the mixer itself.

Milling media as described above may be used to assist the reaction. In certain embodiments, the dual asymmetric centrifugal forces may be applied in a stepwise manner in which milling media may be used for some, but not all, periods of time.

The process may be carried out in a wet environment i.e. an environment where solvent is present. For example, acetonitrile may added to the mixture of pinoxaden and herbicidal coformer. Acetonitrile can act to minimise particle welding. The addition of acetonitrile may be particularly helpful if the pinoxaden and/or herbicidal coformer being reacted has agglomerated prior to use, in which case the acetonitrile can assist with breaking down the agglomerates.

When the dual asymmetric centrifugal forces are applied for an aggregate period of time, the wet or dry environment may be changed for each period of time. For example, the process may comprise a first period of time in which the environment is dry (i.e. pinoxaden and the herbicidal conformer are reacted together optionally with milling media in the absence of solvent), and a second period of time in which the environment is wet after the addition of solvent.

The herbicidal coformer may be present in stoichiometric or excess molar equivalents to the pinoxaden. In one embodiment, the herbicidal coformer is present in stoichiometric quantities.

In another aspect, the crystalline pinoxaden herbicidal coformer molecular complexes described above may be prepared by a process comprising the steps of:
(a) forming a solution of the herbicide pinoxaden and a second herbicide in a solvent selected from acetonitrile, isopropyl acetate, or a mixture thereof,
   wherein the second herbicide selected from the group consisting of fluroxypyr, 2,4-dichlorophenoxyacetic acid, 2-methyl-4-chlorophenoxyacetic acid, and 3,6-dichloro-2-methoxybenzoic acid;
(b) forming a solution or suspension of the molecular complex in the solvent; and
(c) recovering the molecular complex as a crystalline solid.

Pinoxaden and the active herbicidal coformers are as described above.

In one embodiment, the solvent is acetonitrile. In another embodiment, the solvent is isopropyl acetate. In yet another embodiment, the solvent is a mixture of acetonitrile and isopropyl acetate.

The quantity of solvent is not particularly limiting provided there is enough solvent to substantially dissolve pinoxaden and the herbicidal coformer. If a suspension or hazy solution remains on contacting pinoxaden and/or the herbicidal conformer with the solvent, a second or further quantities of solvent may be added until a solution is formed, or the suspension or hazy solution may be filtered.

The solution of pinoxaden and the herbicidal coformer may formed at ambient temperature or less. Alternatively, the pinoxaden and the conformer may be contacted with the solvent at a temperature greater than ambient i.e. greater than 30° C. and below the boiling point of the reaction mixture. The boiling point of the reaction mixture may vary depending on the pressure under which the contacting step is conducted. In one embodiment, the contacting step is carried out at atmospheric pressure (i.e.

1.0135×10⁵ Pa). In one embodiment, the contacting step may be carried out at one or more temperatures in the range of ≥about 40° C. to ≤about 70° C. In some embodiments, the contacting step is carried out at one or more temperatures ≥about 40° C. In some embodiments, the contacting step is carried out at one or more temperatures ≥about 41° C. In some embodiments, the contacting step is carried out at one or more temperatures ≥about 42° C. In some embodiments, the contacting step is carried out at one or more temperatures ≥about 43° C. In some embodiments, the contacting step is carried out at one or more temperatures ≥about 44° C. In some embodiments, the contacting step is carried out at one or more temperatures ≥about 45° C. In some embodiments, the contacting step is carried out at one or more temperatures ≥about 46° C. In some embodiments, the contacting step is carried out at one or more temperatures ≥about 47° C. In some embodiments, the contacting step is carried out at one or more temperatures ≥about 48° C. In some embodiments, the contacting step is carried out at one or more temperatures ≥about 49° C. In some embodiments, the contacting step is carried out at one or more temperatures ≥about 50° C. In some embodiments, the contacting step is carried out at one or more temperatures ≤about 70° C. In some embodiments, the contacting step is carried out at one or more temperatures ≤about 69° C. In some embodiments, the contacting step is carried out at one or more temperatures ≤about 68° C. In some embodiments, the contacting step is carried out at one or more temperatures ≤about 67° C. In some embodiments, the contacting step is carried out at one or more temperatures ≤about 66° C. In some embodiments, the contacting step is carried out at one or more temperatures ≤about 65° C. In some embodiments, the contacting step is carried out at one or more temperatures ≤about 64° C. In some embodiments, the contacting step is carried out at one or more temperatures ≤about 63° C. In some embodiments, the contacting step is carried out at one or more temperatures ≤about 62° C. In some embodiments, the contacting step is carried out at one or more temperatures ≤about 61° C. In some embodiments, the contacting step is carried out at one or more temperatures ≤about 60° C. In one embodiment, the contacting step is carried out at one or more temperatures in the range of ≥about 55° C. to ≤about 65° C. In one embodiment, the contacting step is carried out at about 60° C.

The dissolution of pinoxaden and/or the herbicidal coformer may be encouraged through the use of an aid such as stirring, shaking and/or sonication.

The solution or suspension may then be cooled such that the resulting solution or suspension has a temperature below that of the solution or suspension step (b). The rate of cooling may be from about 0.05° C./minute to about 2° C./minute, such as about 0.5° C./minute to about 1.5° C./minute, for example about 0.1° C./minute. When a solution of molecular complex is cooled, a suspension may eventually be observed. When a suspension of molecular complex is cooled, no perceptible change in the appearance of the suspension may occur.

The solution or suspension may be cooled to ambient temperature or a temperature of less than ambient temperature. In one embodiment, the solution or suspension may be cooled to one or more temperatures in the range of ≥about 0° C. to ≤about 20° C. In some embodiments, the solution or suspension is cooled to one or more temperatures ≥about 1° C. In some embodiments, the solution or suspension is cooled to one or more temperatures ≥about 2° C. In some embodiments, the solution or suspension is cooled to one or more temperatures ≥about 3° C. In some embodiments, the solution or suspension is cooled to one or more temperatures ≥about 4° C. In some embodiments, the solution or suspension is cooled to one or more temperatures ≥about 5° C. In some embodiments, the solution or suspension is cooled to one or more temperatures ≤about 15° C. In some embodiments, the solution or suspension is cooled to one or more temperatures ≤about 14° C. In some embodiments, the solution or suspension is cooled to one or more temperatures ≤about 13° C. In some embodiments, the solution or suspension is cooled to one or more temperatures ≤about 12° C. In some embodiments, the solution or suspension may be cooled to one or more temperatures ≤about 11° C. In some embodiments, the solution or suspension is cooled to one or more temperatures ≤about 10° C. In one embodiment, the solution or suspension is cooled to one or more temperatures in the range of about 0° C. to about 10° C., for example, about 5° C.

In step (c), the molecular complex is recovered as a crystalline solid. The crystalline molecular complex may be recovered by directly by filtering, decanting or centrifuging. The crystalline molecular complex formed may be optionally slurried in a suitable solvent or solvent mixture in order to purify the crystalline molecular complex or remove an excess of one of the starting materials.

Howsoever the crystalline molecular complex is recovered, the separated solid may be washed one or more times with a suitable solvent or solvent mixture and dried. Drying may be performed using known methods, for example, at temperatures in the range of about 10° C. to about 60° C., such as about 20° C. to about 40° C., for example, ambient temperature under vacuum (for example about 1 mbar to about 30 mbar) for about 1 hour to about 24 hours. It is preferred that the drying conditions are maintained below the point at which the molecular complex degrades and so when the molecular complex is known to degrade within the temperature or pressure ranges given above, the drying conditions should be maintained below the degradation temperature or vacuum.

Steps (a) to (c) may be carried out one or more times (e.g. 1, 2, 3, 4 or 5 times).

The solution or suspension formed in step (a) and/or step (b) may be optionally seeded with crystalline molecular complex (which is previously prepared and isolated by a method described herein).

Alternatively or in addition, seeds may be added when the solution or suspension is cooled. For example, the solution or suspension formed in step (b) may be cooled to one temperature below that of the solution or suspension of step (b), seeds may be added, and the solution or suspension further cooled to ambient temperature or a temperature less than ambient temperature as described above. The seeds of the crystalline molecular complex are previously prepared and isolated by a method described herein.

The molecular complexes may be formulated into a herbicidal composition with at least one agriculturally acceptable carrier. The compositions may be solids, for example powders, granules, or water-dispersible powders, or may be liquids, such as suspensions of molecular complex particles (i.e. a solid-liquid formulation).

Alternative formulations of the molecular complexes may comprise a suspended stabilised emulsion (i.e. liquid-liquid formulation).

Suitable agriculturally acceptable carriers are well known to those skilled in the art. Such carriers should not be phytotoxic to crops, in particular at the concentrations employed for the control of undesirable plants in the presence of crops, and should not react chemically with the compounds of the molecular complex or other composition components. The compositions may be applied directly, or may be formulations or concentrates which are diluted, for example with water, prior to application.

Liquid carriers that may be employed include water and organic solvents, although it is typically preferred that water is used. Solid carriers include mineral earths, such as clays, silicates, diatomaceous earths, or kaolin, fertilisers, and organic products such as woodmeal and cellulose carriers.

It will be understood by the skilled person that the compositions may also include further components, such as surfactants, viscosity modifiers, anti-freeze agents, agents for pH control, stabilisers and anti-caking agents.

The concentration of active ingredients in the composition is generally between about 1 and about 99 wt %, such as between about 5 and about 95 wt % or about 10 and about 90 wt %. In compositions which are designed to be diluted prior to use the concentration of active ingredients may be between about 10 and about 90 wt %. Such compositions are then diluted, for example with water, to compositions which may contain about 0.001 and about 1 wt % of active material.

The compositions as described herein may be used for controlling or substantially eliminating undesirable vegetation. Undesirable vegetation is understood to mean plants considered undesirable in a particular location, e.g. in an area of crops, and may be known as weeds.

Control may be achieved by a method comprising contacting the vegetation with the herbicidal composition. It will be understood by the skilled person that the composition at the point of application should contain a herbicidally effective amount of the molecular complex. A herbicidally effective amount is an amount of the active ingredients which causes an adverse deviation of the natural development of the undesired vegetation.

The compositions may have utility for controlling undesirable vegetation in a culture of crop plants, especially crop plants which are tolerant to pinoxaden, fluroxypyr, 2,4-dichlorophenoxyacetic acid, 2-methyl-4-chlorophenoxyacetic acid or 3,6-dichloro-2-methoxybenzoic acid, for example through genetic modification of the crop plants. The compositions may also have utility for the control of undesirable vegetation which is resistant to pinoxaden, fluroxypyr, 2,4-dichlorophenoxyacetic acid, 2-methyl-4-chlorophenoxyacetic acid or 3,6-dichloro-2-methoxybenzoic acid.

Embodiments and/or optional features of the invention have been described above. Any aspect of the invention may be combined with any other aspect of the invention, unless the context demands otherwise. Any of the embodiments or optional features of any aspect may be combined, singly or in combination, with any aspect of the invention, unless the context demands otherwise.

The invention will now be described further by reference to the following examples, which are intended to illustrate but not limit, the scope of the invention.

### EXAMPLES

Instrument and Methodology Details

XRPD Method

XRPD diffractograms were collected on a Bruker D8 diffractometer. Bruker D8 uses Cu Kα radiation (40 kV, 40 mA) and a θ-2θ goniometer fitted with a Ge monochromator. The incident beam passes through a 2.0 mm divergence slit followed by a 0.2 mm anti-scatter slit and knife edge. The diffracted beam passes through an 8.0 mm receiving slit with 2.5° Soller slits followed by the Lynxeye Detector. The software used for data collection and analysis was Diffrac Plus XRD Commander and Diffrac Plus EVA respectively.

Samples were run under ambient conditions as flat plate specimens using powder as received. The sample was prepared on a polished, zero-background (510) silicon wafer by gently pressing onto the flat surface or packed into a cut cavity. The sample was rotated in its own plane.

The details of the standard collection method are:
Angular range: 2 to 42° 2θ
Step size: 0.05° 2θ
Collection time: 0.5 s/step (total collection time: 6.40 min)

DSC Method

DSC (melting point) was assessed using either a TA Instruments Q2000 or TA Instruments Discovery DSC. Typically, 0.5-3 mg of each sample, in a pin-holed aluminium pan, was heated at 10° C./min from 25° C. to 300° C. A purge of dry nitrogen at 50 ml/min was maintained over the sample.

Thermodynamic Solubility

Aqueous solubility was determined by suspending sufficient amount of compound in 0.5 ml media for a maximum anticipated concentration of ca. 10 mg/ml. The suspension was equilibrated at 25° C., on a Heidolph plate shaker set to 750 rpm for 24 hours. The pH of the sample solutions was periodically checked and, if required, adjusted with 0.2M NaOH to ensure that the desired pH was maintained (±0.05) throughout. The pH of the saturated solution after this time was measured and the suspension filtered through a glass fibre C filter (particle retention 1.2 μm) and diluted appropriately.

Quantitation was by HPLC with reference to a standard solution of approximately 0.15 mg/ml in 1:1 MeCN/H₂O. Different volumes of the standard, diluted and undiluted sample solutions were injected.

Different volumes of the standard, diluted and undiluted sample solutions were injected. The solubility was calculated using the peak areas determined by integration of the peak found at the same retention time as the principal peak in the standard injection.

Analysis was performed on an Agilent HP1100 series system equipped with a diode array detector and using ChemStation software.

HPLC method for solubility measurements:

| Type of method | Reverse phase with gradient elution | | |
|---|---|---|---|
| Method file name: | SOL GENERIC VERSION 4.M | | |
| Assay type: | Solubility | | |
| Column: | Phenomenex Luna, C18 (2) 5 μm 50 × 4.6 mm | | |
| Column Temperature (° C.): | 25 | Autosampler | Ambient |
| | | temperature (° C.) | |
| Standard Injections (μl): | 1, 2, 3, 4, 5, 7 | | |
| Sample Injections (μl): | 1, 2, 3, 10, 15, 20 | | |
| Detection: | 255 or 260, 90 | | |
| Wavelength & Bandwidth (nm): | | | |
| Flow Rate (ml/min): | 2.0 | | |
| Mobile Phase A: | 0.1% TFA in Water | | |
| Mobile Phase B: | 0.085% TFA in Acetonitrile | | |
| Timetable: | Time (min) | % Phase A | % Phase B |
| | 0.0 | 95.0 | 5.0 |
| | 1.0 | 80.0 | 20.0 |
| | 2.3 | 5.0 | 95.0 |
| | 3.3 | 5.0 | 95.0 |
| | 3.5 | 95.0 | 5.0 |
| | 4.4 | 95.0 | 5.0 |

IDR Method

Ca. 40 mg material was compressed under 100 kg for 2 minutes to form non-disintegrating discs. The discs were then plugged with a bung so that only one surface was exposed to the media during analysis, and transferred to the dissolution apparatus (Sirius inForm). The volume of the assay was 40 ml and a stir speed of 225 rpm was used. Analysis was performed at 37° C. in pH 5.0 media for 1 hour with UV spectra collected every 30 seconds, using a 20 mm path length probe. Intrinsic dissolution rate (IDR) was calculated based on the surface area of the disc used, in this case a 6 mm disc (surface area: 28.3 mm²).

### Example 1—Preparation of Molecular Complex Seeds for Example 1

Pinoxaden (32 mg) (PTG Advanced Catalyst Co.) and fluroxypyr (20 mg) (Sigma Aldrich) were wetted with acetonitrile (10 μl) and ground for 2 hours at 500 rpm in a Fritsch planetary mill. The resulting solids were air-dried for 30 minutes before analysis. XRPD of the obtained solid was consistent with that given in FIG. 1.

### Example 2—Pinoxaden:Fluroxypyr (1:1) Molecular Complex

Pinoxaden (800 mg) (PTG Advanced Catalyst Co.) and fluroxypyr (510 mg, 1 mol eq.) (Sigma Aldrich) were stirred in acetonitrile (5 ml) at 60° C. for 2 hours. The resulting suspension was allowed to cool to 35° C. and seeded with co-crystal prepared in Example 1. The sample was placed at 5° C. for 48 hours and the resulting suspension was filtered. The solid was air dried at RT and analysed by XRPD, which showed a crystalline material and yielded a diffractogram as provided in FIG. 1.

The following table provides an XRPD peak list for the pinoxaden:fluroxypyr (1:1) molecular complex:

| Angle | Intensity |
|---|---|
| (2-Theta °) | (%) |
| 6.8 | 100.0 |
| 9.1 | 10.3 |
| 10.8 | 18.2 |
| 11.2 | 39.3 |
| 12.1 | 13 |
| 12.8 | 45.9 |
| 13.3 | 6.5 |
| 13.5 | 10.1 |
| 13.7 | 5.9 |
| 14.8 | 4.8 |
| 15.7 | 5.1 |
| 15.8 | 8.5 |
| 17.0 | 9.4 |
| 17.2 | 20 |
| 17.7 | 10.2 |
| 18.2 | 15.1 |
| 18.6 | 6.1 |
| 18.9 | 7.7 |
| 19.2 | 14.9 |
| 19.4 | 52.1 |
| 19.8 | 7.9 |
| 19.9 | 9.1 |
| 20.7 | 27.5 |
| 21.2 | 6.6 |
| 21.4 | 11.6 |
| 22.3 | 11.1 |
| 22.6 | 3.8 |
| 23.0 | 54.6 |
| 23.2 | 11.8 |
| 23.4 | 8.1 |
| 23.9 | 8.0 |
| 24.1 | 17.5 |
| 24.5 | 37.5 |
| 24.7 | 36.6 |
| 25.2 | 11 |
| 25.5 | 5.5 |
| 25.9 | 13.8 |
| 26.3 | 8.1 |
| 26.8 | 9.9 |
| 27.1 | 6.6 |
| 27.5 | 7.1 |
| 28.0 | 3.8 |
| 28.1 | 4.8 |
| 28.7 | 19.8 |
| 29.5 | 6.1 |
| 30.0 | 5.4 |
| 30.2 | 4.9 |
| 30.4 | 9.9 |
| 30.6 | 6.3 |
| 30.8 | 4.1 |
| 31.6 | 7 |
| 32.0 | 7.2 |
| 32.3 | 4.7 |
| 33.7 | 5.0 |
| 34.0 | 4.5 |
| 34.2 | 6.7 |
| 34.6 | 5.1 |
| 34.7 | 7.4 |
| 35.1 | 6.5 |
| 35.4 | 8.7 |
| 35.8 | 4.2 |
| 36.2 | 5.0 |
| 38.4 | 4.8 |
| 39.2 | 4.8 |
| 41.0 | 4.9 |

The molecular complex was also characterised by DSC (FIG. 2). DSC analysis indicated a melting point with an onset temperature of about 160.5° C.

The sample was further analysed by single crystal x-ray crystallography to determine the crystal structure as follows. The asymmetric unit contains one disordered molecule of pinoxaden and one fully ordered molecule of fluroxypyr. The ethyl group of pinoxaden has been modelled over two sites with a 73.5:26.5 ratio, whereas the tert-butyl group has been modelled with over two sites with a 74:26 ratio.

Data collection and structure refinement for Pinoxaden:Fluroxypyr

Diffractometer SuperNova, Dual, Cu at zero, Atlas

Radiation source SuperNova (Cu) X-ray Source, CuKα

Data collection method omega scans

Theta range for data collection 3.460 to 70.259°

Index ranges −14≤h≤14, −12≤k≤12, −31≤l≤22

Reflections collected 58505

Independent reflections 5988 [R(int)=0.0360]

Coverage of independent reflections 100.0%

Variation in check reflections n/a

Absorption correction Semi-empirical from equivalents

Max. and min. transmission 1.00000 and 0.92818

Structure solution technique Direct methods

Structure solution program SHELXTL (Sheldrick, 2013)

Refinement technique Full-matrix least-squares on F²

Refinement program SHELXL-2013 (Sheldrick, 2013)

Function minimized Σw(Fₒ²−F_{c}²)²

Data/restraints/parameters 5988/94/457

Goodness-of-fit on F² 1.007

Δ/σₘₐₓ 0.002

Final R indices
5404 data; l>2σ(l) R1=0.0327, wR2=0.0810
all data R1=0.0374, wR2=0.0852

Weighting scheme w=1/[σ² (Fₒ²)+(0.0414 P)²+2.1171 P]
where P=(Fₒ²−2F_{c}²)²/3

Extinction coefficient n/a

Largest diff. peak and hole 0.617 and −0.472 eÅ⁻³

Sample and Crystal Data For Pinoxaden:Fluroxypyr

Compound pinoxaden:fluroxypyr molecular complex (1:1)

Crystallisation solvents Acetonitrile

Crystallisation method Slow evaporation

Empirical formula C₃₀H₃₇Cl₂FN₄O₇

Formula weight 655.53

Temperature 100(2) K

Wavelength 1.54184 Å

Crystal size 0.300×0.220×0.220 mm

Crystal habit colourless prism

Crystal system Monoclinic

Space group P2₁/n

Unit cell dimensions a=11.80948(13) Å α=90°
b=10.43134(13) Å β=94.7930(10)°
c=25.6391(2) Å γ=90°

Volume 3147.41(6) Å3

Z 4

Density (calculated) 1.383 Mg/m3

Absorption coefficient 2.354 mm-1

F(000) 1376

### Example 3—Pinoxaden:2,4-D (1:1) Molecular Complex

Pinoxaden (300 mg) (PTG Advanced Catalyst Co.) and 2,4-D (165 mg, 1 mol eq.) (Sigma Aldrich) were stirred in isopropyl acetate (15 ml) at 60° C. for 2 hours to achieve a clear solution, then cooled to 5° C. at 0.1° C./min. The resulting suspension was filtered and air dried at room temperature. The solid was analysed by XRPD, which showed a crystalline material and yielded a diffractogram as provided in FIG. 3.

The following table provides an XRPD peak list for the pinoxaden:2,4-D (1:1) molecular complex:

| Angle | Intensity |
|---|---|
| (2-Theta °) | (%) |
| 3.9 | 100.0 |
| 7.9 | 13.1 |
| 11.4 | 1.0 |
| 11.9 | 7.6 |
| 12.1 | 3.0 |
| 13.1 | 2.0 |
| 14.0 | 0.6 |
| 15.1 | 5.1 |
| 15.8 | 0.7 |
| 16.8 | 1.5 |
| 18.0 | 0.6 |
| 18.2 | 2.0 |
| 18.6 | 1.1 |
| 19.6 | 2.0 |
| 19.9 | 2.9 |
| 20.2 | 3.1 |
| 20.8 | 1.2 |
| 21.1 | 3.6 |
| 21.9 | 3.1 |
| 23.4 | 1.7 |
| 23.9 | 2.2 |
| 24.3 | 2.3 |
| 24.4 | 3.0 |
| 24.7 | 3.4 |
| 25.3 | 1.0 |
| 25.4 | 0.9 |
| 25.6 | 1.1 |
| 26.7 | 1.6 |
| 27.0 | 0.7 |
| 27.2 | 1.2 |
| 27.9 | 8.6 |
| 28.7 | 1.8 |
| 30.1 | 1.0 |
| 30.3 | 1.1 |
| 30.7 | 1.3 |
| 32.0 | 2.9 |
| 33.3 | 0.8 |
| 37.8 | 0.9 |

The molecular complex was also characterised by DSC (FIG. 4). DSC analysis indicated a melting point with an onset temperature of about 154.1° C.

### Example 4—Pinoxaden:MCPA (1:1) Molecular Complex

Pinoxaden (300 mg) (PTG Advanced Catalyst Co.) and MCPA (150 mg, 1 mol eq.) (Sigma Aldrich) were stirred in isopropyl acetate (13 ml) at 60° C. for 2 hours to achieve a clear solution, then cooled to 5° C. at 0.1° C./min. The resulting suspension was filtered and air dried at room temperature. The solid was analysed by XRPD, which showed a crystalline material and yielded a diffractogram as provided in FIG. 5.

The following table provides an XRPD peak list for the pinoxaden:MCPA (1:1) molecular complex:

| Angle | Intensity |
|---|---|
| (2-Theta °) | (%) |
| 3.9 | 100.0 |
| 7.7 | 64.4 |
| 11.6 | 4.1 |
| 12.0 | 8.3 |
| 13.2 | 3.0 |
| 14.1 | 0.8 |
| 14.9 | 1.3 |
| 15.4 | 10.2 |
| 15.6 | 5.0 |
| 16.8 | 2.3 |
| 18.0 | 3.4 |
| 18.2 | 1.6 |
| 19.5 | 1.1 |
| 19.9 | 6.4 |
| 20.4 | 4.8 |
| 21.1 | 5.2 |
| 21.7 | 1.5 |
| 22.2 | 0.6 |
| 23.4 | 3.4 |
| 23.8 | 2.8 |
| 24.6 | 6.4 |
| 25.0 | 3.6 |
| 26.1 | 1.5 |
| 26.6 | 0.9 |
| 27.4 | 11.4 |
| 28.5 | 2.3 |
| 29.7 | 1.2 |
| 30.1 | 0.9 |
| 30.4 | 1.2 |
| 31.0 | 1.0 |
| 31.4 | 2.7 |
| 31.8 | 1.0 |
| 32.4 | 0.9 |
| 35.0 | 0.7 |
| 36.8 | 1.7 |
| 37.8 | 0.9 |
| 39.5 | 1.2 |

The molecular complex was also characterised by DSC (FIG. 6). DSC analysis indicated a melting point with an onset temperature of about 150.7° C.

### Example 5—Pinoxaden:Dicamba (1:1) Molecular Complex

Pinoxaden (300 mg) (PTG Advanced Catalyst Co.) and dicamba (166 mg, 1 mol eq.) (Sigma Aldrich) were stirred in isopropyl acetate (13 ml) at 50° C. for 1 hour to achieve a clear solution, then cooled to 5° C. at 0.1° C./min. A clear solution remained, which was treated with heptane (3 ml) until a precipitate formed. The sample was filtered and air dried at room temperature. The resulting solid was analysed by XRPD, which showed a crystalline material and yielded a diffractogram as provided in FIG. 7.

The following table provides an XRPD peak list for the pinoxaden:dicamba (1:1) molecular complex:

| Angle | Intensity |
|---|---|
| (2-Theta °) | (%) |
| 7.2 | 88.2 |
| 8.6 | 34.4 |
| 10.3 | 24.5 |
| 11.4 | 100.0 |
| 12.2 | 60.1 |
| 12.8 | 62.8 |
| 13.9 | 21.8 |
| 15.2 | 51.1 |
| 15.7 | 13.1 |
| 16.2 | 23.2 |
| 16.9 | 18.0 |
| 17.2 | 39.6 |
| 17.8 | 27.2 |
| 18.2 | 20.7 |
| 18.7 | 13.7 |
| 19.3 | 47.5 |
| 19.9 | 14.2 |
| 20.7 | 82.1 |
| 21.0 | 56.3 |
| 21.4 | 46.3 |
| 21.6 | 24.5 |
| 22.8 | 11.7 |
| 23.0 | 42.6 |
| 23.8 | 14.0 |
| 24.4 | 18.4 |
| 25.2 | 27.0 |
| 26.2 | 13.9 |
| 26.4 | 25.8 |
| 27.1 | 12.8 |
| 27.4 | 13.3 |
| 27.8 | 13.0 |
| 28.2 | 38.7 |
| 28.5 | 16.4 |
| 28.9 | 13.9 |
| 31.4 | 13.1 |
| 31.6 | 13.1 |
| 33.9 | 15.7 |
| 37.1 | 12.4 |

The molecular complex was also characterised by DSC (FIG. 8). DSC analysis indicated a melting point with an onset temperature of about 118.1° C.

### Example 6

The following table provide a comparison of DSC (melting points) and IDR analyses (solubility) for co-crystals of pinoxaden from Example 2 to Example 5:

| | | | IDR of | |
|---|---|---|---|---|
| | | DSC | pinoxaden | IDR of second |
| | Component(s) of | melting point | component | component |
| Example | interest | (° C.) | (μg/min/cm²) | (μg/min/cm²) |
| | Pinoxaden freeform | 120.5-121,6^{a} | 69.4 | n/a |
| 2 | Pinoxaden: | 160.5 | 64.5 | 104.5 |
| | Fluroxypyr (1:1) | | | |
| | Fluroxypyr freeform | 232^{b} | n/a | 956.9 |
| 3 | Pinoxaden: 2,4-D | 154.1 | n/a | n/a |
| | (1:1) | | | |
| 4 | Pinoxaden: MCPA | 150.7 | n/a | n/a |
| | (1:1) | | | |
| 5 | Pinoxaden: | 118.1 | n/a | n/a |
| | Dicamba (1:1) | | | |

^{a}MacBean C, ed; e-Pesticide Manual. 15th ed., ver. 5.1, Alton, UK; British Crop Protection Council. Pinoxaden (243973-20-8) (2008-2010)
^{b}Lide, D.R. CRC Handbook of Chemistry and Physics 88TH Edition 2007-2008. CRC Press, Taylor & Francis, Boca Raton, FL 2007, p. 3-262

The following table provides a comparison of thermodynamic solubilities for co-crystals of pinoxaden from Example 2 to Example 5:

| | | | | Thermodynamic | Thermodynamic |
|---|---|---|---|---|---|
| | | | | solubility of | solubility of |
| | | | | pinoxaden | second |
| | Component(s) | | Final | component | component |
| Example | of Interest | Media | pH | (mg/ml) | (mg/ml) |
| | Pinoxaden | DI Water | 3.97 | ca. 0.23 | n/a |
| | freeform | | | | |
| | Fluroxypyr | | 4.04 | n/a | 0.29 |
| | freeform | | | | |
| 2 | Pinoxaden: | | 4.10 | ca. 0.01 | 0.25 |
| | Fluroxypyr (1:1) | | | | |
| 3 | Pinoxaden: | DI Water, | 5.24 | 0.20 | 0.12 |
| | 2,4-D (1:1) | pH 7.8 | | | |
| 4 | Pinoxaden: | | 5.42 | 0.20 | 0.11 |
| | MCPA (1:1) | | | | |
| | Pinoxaden | pH 4.0 media | 4.00 | 0.28 | n/a |
| | freeform | (42.4 ml 0.1 M | | | |
| | Dicamba | acetic acid mixed | 3.98 | n/a | >13.8 |
| | freeform | with 7.6 ml 0.1 M | | | |
| 5 | Pinoxaden: | sodium acetate) | 3.97 | 0.31 | >5.3 |
| | Dicamba (1:1) | | | | |

1. A crystalline molecular complex comprising:
(a) the herbicide pinoxaden, and
(b) a second herbicide selected from the group consisting of fluroxypyr, 2,4-dichlorophenoxyacetic acid, 2-methyl-4-chlorophenoxyacetic acid and 3,6-dichloro-2-methoxybenzoic acid.

2. A crystalline molecular complex according to claim 1, wherein the molar ratio of pinoxaden:the second herbicide may be from about 0.1:about 5 to about 5:about 0.1.

3. A crystalline molecular complex according to claim 1, wherein the molecular complex is crystalline pinoxaden fluroxypyr molecular complex having an X-ray powder diffraction pattern comprising one or more peaks selected from the group consisting of about 6.8, 9.1, 10.8, 11.2, 12.1, 12.8, 13.3, 13.5, 13.7, 14.8, 15.7, 15.8, 17.0, 17.2, 17.7, 18.2, 18.6, 18.9, 19.2, 19.4, 19.8, 19.9, 20.7, 21.2, 21.4, 22.3, 22.6, 23.0, 23.2, 23.4, 23.9, 24.1, 24.5, 24.7, 25.2, 25.5, 25.9, 26.3, 26.8, 27.1, 27.5, 28.0, 28.1, 28.7, 29.5, 30.0, 30.2, 30.4, 30.6, 30.8, 31.6, 32.0, 32.3, 33.7, 34.0, 34.2, 34.6, 34.7, 35.1, 35.4, 35.8, 36.2, 38.4, 39.2, and 41.0 degrees two-theta±0.2 degrees two-theta.

4. A crystalline molecular complex according to claim 3, which has the X-ray powder diffraction pattern substantially as shown in FIG. 1.

5. A crystalline molecular complex according to claim 1, wherein the molecular complex is crystalline pinoxaden 2,4-dichlorophenoxyacetic acid molecular complex having an X-ray powder diffraction pattern comprising one or more peaks selected from the group consisting of about 3.9, 7.9, 11.4,11.9,12.1,13.1,14.0,15.1,15.8,16.8,18.0,18.2,18.6,19.6, 19.9, 20.2, 20.8, 21.1, 21.9, 23.4, 23.9, 24.3, 24.4, 24.7, 25.3, 25.4, 25.6, 26.7, 27.0, 27.2, 27.9, 28.7, 30.1, 30.3, 30.7, 32.0, 33.3, and 37.8 degrees two-theta±0.2 degrees two-theta.

6. A crystalline molecular complex according to claim 5, which has the X-ray powder diffraction pattern substantially as shown in FIG. 3.

7. A crystalline molecular complex according to claim 1, wherein the molecular complex is crystalline pinoxaden 2-methyl-4-chlorophenoxyacetic acid molecular complex having an X-ray powder diffraction pattern comprising one or more peaks selected from the group consisting of about 3.9, 7.7, 11.6, 12.0, 13.2, 14.1, 14.9, 15.4, 15.6, 16.8, 18.0, 18.2, 19.5, 19.9, 20.4, 21.1, 21.7, 22.2, 23.4, 23.8, 24.6, 25.0, 26.1, 26.6, 27.4, 28.5, 29.7, 30.1, 30.4, 31.0, 31.4, 31.8, 32.4, 35.0, 36.8, 37.8, and 39.5 degrees two-theta±0.2 degrees two-theta.

8. A crystalline molecular complex according to claim 7, which has the X-ray powder diffraction pattern substantially as shown in FIG. 5.

9. A crystalline molecular complex according to claim 1, wherein the molecular complex is crystalline pinoxaden 3,6-dichloro-2-methoxybenzoic acid molecular complex having an X-ray powder diffraction pattern comprising one or more peaks selected from the group consisting of about 7.2, 8.6, 10.3, 11.4, 12.2, 12.8, 13.9, 15.2, 15.7, 16.2, 16.9, 17.2, 17.8, 18.2, 18.7, 19.3, 19.9, 20.7, 21.0, 21.4, 21.6, 22.8, 23.0, 23.8, 24.4, 25.2, 26.2, 26.4, 27.1, 27.4, 27.8, 28.2, 28.5, 28.9, 31.4, 31.6, 33.9, and 37.1 degrees two-theta±0.2 degrees two-theta.

10. A crystalline molecular complex according claim 9, which has the X-ray powder diffraction pattern substantially as shown in FIG. 7.

11. A process for preparing the molecular complexes as claimed in claim 1, the process comprising process comprising the step of reacting pinoxaden and a second herbicide using low energy ball milling or low energy grinding,
wherein the second herbicide is selected from the group consisting of fluroxypyr, 2,4-dichlorophenoxyacetic acid, 2-methyl-4-chlorophenoxyacetic acid, and 3,6-dichloro-2-ethoxybenzoic acid.

12. A process for preparing the molecular complexes as claimed in claim 1, the process comprising process comprising applying dual asymmetric centrifugal forces to a mixture of pinoxaden and a second herbicide to form the molecular complex,
wherein the second herbicide selected from the group consisting of fluroxypyr, 2,4-dichlorophenoxyacetic acid, 2-methyl-4-chlorophenoxyacetic acid, and 3,6-dichloro-2-methoxybenzoic acid.

13. A process for preparing the molecular complexes as claimed in claims 1, the process comprising the steps of:
(a) forming a solution of the herbicide pinoxaden and a second herbicide in a solvent selected from acetonitrile, isopropyl acetate, or a mixture thereof,
wherein the second herbicide selected from the group consisting of fluroxypyr, 2,4-dichlorophenoxyacetic acid, 2-methyl-4-chlorophenoxyacetic acid and 3,6-dichloro-2-methoxybenzoic acid;
(b) forming a solution or suspension of the molecular complex in the solvent; and
(c) recovering the molecular complex as a crystalline solid.

14. A herbicidal composition comprising a molecular complex as claimed in claim 1 and at least one agriculturally acceptable carrier.

15. A herbicidal composition according to claim 14, wherein the composition is an aqueous suspension or granules.

16. The use of an herbicidal composition according to claim 14 for controlling or substantially eliminating undesired vegetation.

17. A method for controlling undesired vegetation comprising contacting the vegetation with a herbicidal composition according to claim 14.
